(19) United States
(12) Patent Application Publication
(10) Pub. No.: US 2025/0118150 A1
(43) Pub. Date: Apr. 10, 2025

(54) MOBILE MICROSITE INTEGRATION AND SECURITY

(71) Applicant: OBeP Payments, LLC, San Carlos, CA (US)

(72) Inventor: Michael Beispel, New York, NY (US)

(21) Appl. No.: 18/378,058

(22) Filed: Oct. 9, 2023

(51) Int. Cl. G07F 17/32; H04L 9/40

(52) U.S. Cl. CPC G07F 17/3225; G07F 17/3241; H04L 63/0807

(57) ABSTRACT

The present technology can provide solutions for mobile integration for authorizing a certain amount of gameplay on an electronic gaming machine, wherein the electronic gaming machine communicates with a security server that analyzes, using a risk engine, to determine and confirm the authorized gameplay amount to the electronic gaming machine.

### BACKGROUND OF THE INVENTION

### 1. Field of the Disclosure

The present technology generally relates to a method for integrating a mobile, microsite, remote authorization server, and electronic gaming or other types of electronic machine workflows while maintaining security over electronic data exchanges. More specifically, the present technology relates to remote authentication and authorization of specified amounts of gameplay, product, or services at electronic gaming and other machines.

### 2. Description of the Related Art

Presently available electronic machines may be used to provide certain goods or services. Examples of such electronic machines ma include vending machines, electronic kiosks, electronic booths, electronic pods, or other electronic point-of-service (POS) machines, etc. Each such electronic machine may be configured and/or programmed to provide a specific unit of goods or services, for example, by opening/unlocking a locked compartment, dispensing an product (e.g., by a certain amount), performing a programmed service for a specified time period, providing access to a programmed or online service for a specified time period, etc.

One type of service that may be provided by electronic machines is gameplay or gaming activities supported by electronic gaming machines. Electronic gaming machines may be inclusive of any type of mechanical or digital device used by one or more players to play games of chance. For example, electronic gaming machines may include slot machines, video poker machines, pachinko machines, etc., that allow for players to engage in specific amounts of gaming activities where outcomes (e.g., winning or losing) result from elements of randomness or chance.

Depending on the type of game, the associated gaming activities may include pulls, turns, deals, or another unit of gameplay. Different types of games may include different available gaming activities in different amounts. For example, video poker may include deals, discards, and replacement cards, and the amount of each gaming activity that may be available may vary based on type of poker and associated rules. In addition, during the course of gameplay, the player may elect to make one or more wagers in association with one or more of the gaming activities. Depending on the rules of a particular game type, a predetermined minimum wager may be required into order to proceed with a gaming activity. Such wagers may also be customized or selected by the player to be higher than the minimum.

Historically, electronic gaming machines, such as casino devices, may use either specific physical tokens or articles—including cash, chips, or proprietary players cards or loyalty cards—to initiate a gaming activity at the electronic gaming machines. However, such options have setbacks. For example, physical items may be more difficult to keep track of and may also be more prone to loss, theft, counterfeiting, or other unauthorized uses by unauthorized players. Further, users may need to retrieve such physical tokens or articles in order to play on the electronic gaming machines. The user may, for example, have to search for an automated teller machine (ATM), human teller, or other type of machine or human service provider, as well as have particular account-specific cards readily accessible (which may not be available for various account types), in order to obtain the required physical articles. Such requirements therefore add inconvenience and friction to the user experience.

By contrast, users are generally more conscious of the location of their personal mobile device and may therefore have their respective personal mobile device close at hand. Personal mobile devices may also have embedded or installed their own respective security and authentication systems, which may also be layered with application-based security and authentication. There are presently no ways available, however, to leverage such security and authentication to workflows involving electronic gaming machines and other types of POS electronic machines.

There is, therefore, a need in the art for mobile microsites that would allow for improved integration and security across multiple devices and systems.

### SUMMARY OF THE CLAIMED INVENTION

Disclosed are systems, apparatuses, methods, computer-readable medium, and circuits for integrated security across different online applications and systems. According to at least one example, a method may include receiving a request over a communication network from a first mobile device, the request including a uniform resource locator (URL) encoded within an image scanned by a camera of the first mobile device; launching a first microsite associated with the URL, wherein launching the first microsite includes generating a display that presents one or more options corresponding to a plurality of different remote authorization services and different amounts of gameplay; making a first authorization request over the communication network to a selected remote authorization service of the plurality of remote authorization services and including a selection of one of the different amounts of gameplay; updating the display based on the first authorization request to the selected remote authorization service, wherein the updated display is configured to receive a first authentication information for a user account of the selected remote authorization service from the first mobile device; and authorizing the selected amount of gameplay in association with the user account based on confirmation of the authentication information from the selected remote authorization service and a risk assessment by a risk engine For example, a mobile microsite server receives a request over a communication network from a first mobile device, the request including a uniform resource locator (URL) encoded within an image scanned by a camera of the first mobile device; and launches a first microsite associated with the URL, wherein launching the microsite includes generating a display that presents one or more options corresponding to a plurality of remote authorization services and different amounts of gameplay. A security server is in communication with the mobile microsite server, and makes a first authorization request over the communication network to a remote authorization services associated with a selection of one of the remote authorization service and a selection of one of the different amounts of gameplay presented within the generated display, wherein the display is updated based on the first authorization request to the remote authorization service, wherein the updated display is configured to receive a first authentication information for the selected remote authorization service from the first mobile device; and authorize the selected amount of gameplay based on confirmation of the authentication information from the selected remote authorization service and a risk assessment by a risk engine.

In another example, the security server for processing an amount of gameplay authorization based on a risk engine authorization is provided that includes a storage (e.g., a memory configured to store data, such as virtual content data, one or more images, etc.) and one or more processors (e.g., implemented in circuitry) coupled to the memory and configured to execute instructions and, in conjunction with various components (e.g., a network interface, a display, an output device, etc.), cause the security server to: receive a request over a communication network from a first mobile device, the request including a uniform resource locator (URL) encoded within an image scanned by a camera of the first mobile device; launching a first microsite associated with the URL, wherein launching the first microsite includes generating a display that presents one or more options corresponding to a plurality of different remote authorization services and different amounts of gameplay; make a first authorization request over the communication network to a selected remote authorization service of the plurality of remote authorization services and including a selection of one of the different amounts of gameplay; update the display based on the first authorization request to the selected remote authorization service, wherein the updated display is configured to receive a first authentication information for a user account of the selected remote authorization service from the first mobile device; and authorize the selected amount of gameplay in association with the user account based on confirmation of the authentication information from the selected remote authorization service and a risk assessment by a risk engine.

### BRIEF DESCRIPTION OF THE DRAWINGS

FIG. 1 illustrates an example diagram for a system for processing an amount of gameplay authorization based on a risk engine authorization, according to some aspects of the disclosed technology.

FIG. 2 illustrates an example flow diagram for processing an amount of gameplay authorization based on a risk engine authorization, according to some aspects of the disclosed technology.

FIG. 3A illustrates an example of a mobile device scanning a code associated with an electronic gaming machine, according to some aspects of the disclosed technology.

FIG. 3B illustrates an example graphical user interface view of a camera of the mobile device scanning the code, according to some aspects of the disclosed technology.

FIG. 4A illustrates an example uniform resource locator (URL) encoded within an image scanned by the camera, according to some aspects of the disclosed technology.

FIG. 4B illustrates an example graphical user interface of an instructional splash that provides the steps to be performed by a user, according to some aspects of the disclosed technology.

FIG. 5A illustrates an example graphical user interface of selectable gameplay amounts, according to some aspects of the disclosed technology.

FIG. 5B illustrates an example graphical user interface of selectable remote authorization services, according to some aspects of the disclosed technology.

FIG. 6A illustrates an example graphical user interface of a login screen for authenticating login information associated with a selected remote authorization services, according to some aspects of the disclosed technology.

FIG. 6B illustrates an example graphical user interface of selectable accounts associated with the authenticated login information, according to some aspects of the disclosed technology.

FIG. 7A illustrates an example graphical user interface of a successful authentication of the login information and authorization of the selected amount from the selected account, according to some aspects of the disclosed technology.

FIG. 7B illustrates an example graphical user interface of an option to create a personal identification number (PIN) associated with the selected account or make a one-time authorization, according to some aspects of the disclosed technology.

FIG. 8A illustrates an example graphical user interface that shows that a PIN has been set and an option to complete the authorization of the selected amount from the selected account, according to some aspects of the disclosed technology.

FIG. 8B illustrates an example graphical user interface illustrating a pending authorization screen, according to some aspects of the disclosed technology.

FIG. 9A illustrates an example graphical user interface illustrating a successful authorization screen, according to some aspects of the disclosed technology.

FIG. 9B illustrates an example graphical user interface of an electronic gaming machine that has the authorized amount available for gameplay, according to some aspects of the disclosed technology.

FIG. 10 illustrates an example graphical user interface of the mobile device at a second time after a PIN has been set for the user to select the PIN associated with the selected account, according to some aspects of the disclosed technology.

FIG. 11 illustrates steps of an example process for processing an amount of gameplay authorization based on a risk engine authorization according to some aspects of the disclosed technology, according to some aspects of the disclosed technology.

FIG. 12 illustrates an example processor-based system with which some aspects of the subject technology can be implemented, according to some aspects of the disclosed technology.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

Aspects of the disclosed technology provide solutions for mobile integration for authorizing a certain amount of gameplay consistent with the workflows of different entities while maintaining security and privacy. A player having a mobile device and wishing to engage in gameplay on an electronic gaming machine may scan a code associated with the electronic gaming machine (e.g., QR code), which may automatically launch a microsite hosted by a mobile microsite server that receives selections for amount of gameplay activity and requested authorization service (e.g., account). The security server may then call a software development kit (SDK) or an application programming interface (API) associated with a remote authentication server to launch an authorization flow directly with the mobile device so as to maintain security and privacy and avoid exposure of login and other authentication data to other systems and entities. The amount of gameplay authorization may be confirmed, and the security server may further make a capture API call to confirm capture (e.g., digital transfer or exchange) associated with the authorization by remote authorization server to use a specified account with the requested service or activity. The remote authorization server may also initialize a risk engine to generate a risk assessment associated with the capture based on current applicable conditions (e.g., day, time, selected remote authorization service, selected amounts, recent usage, user information from the remote authorization service or mobile device) and aggregated data regarding similar exchanges. The capture API call may confirm capture in accordance with the remote authorization service or account whereby the confirmed capture may correspond to the requested amount of gameplay. Once the risk assessment indicates that the risk level is below an indicated threshold level and the capture API call have be confirmed, a notification may be sent to confirm the authorized gameplay amount with the mobile device and the security server, the latter of which may then send or provide the electronic gaming machine with instructions in view of the same.

Electronic gaming machines discussed herewith are merely one example of the different types of electronic machines that may be controlled in accordance with authorizations obtained from the mobile microsite integration and security systems and methods described herein. Such other types of electronic machines may be configured to provide other type of products or services upon authentication and authorization by a remote authorization service. For example, the machine may be authorized to perform a requested action such as opening/unlocking a locked compartment, dispensing a product (e.g., specific amount thereof), providing access to an online service (e.g., for specified time period), etc. For example, such electronic machines may include vending machines, kiosks, booths, pods, other POS machines, etc.

As discussed in further detail below, aspects of the technology can be implemented through a mobile microsite server, for example, that is configured to communicate with the mobile device, the security server(s), the remote authorization server, and the electronic game machine(s) using a software connector to the specific website, application, and/or third-party servers. There may therefore be a number of different software connectors (or APIs) configured to communicate with different entity websites, applications, and/or systems and to generate the microsite and other communication protocols.

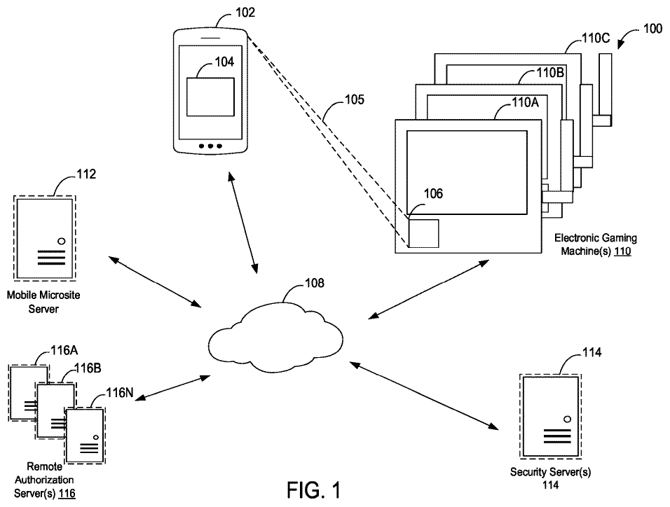

FIG. 1 illustrates an example diagram for a system for processing an amount of gameplay authorization based on a risk engine authorization, according to some aspects of the disclosed technology.

The system 100 may include a mobile device 102, which may be inclusive of mobile phones, tablets, and other handheld or portable device, etc. Mobile device 102 may include a camera that may scan (105) a code 106 associated with an electronic gaming machine 110 and software automatically executable by the mobile device 102 to detect data embedded in an image or scan of the code. The code 106 may or may not be on the electronic gaming machine 110. In scanning the code 106, the mobile device 102 may launch a microsite 104 based on a uniform resource locator (URL) detected as being embedded in the scanned code. The launched microsite 104 may be configured to receive inputs including an amount of gameplay authorization and authorization service (e.g., account type, account service). Once the amount of gameplay authorization is sent to one or more security servers 114, associated with one or more electronic gaming machines (110A, 110B, . . . 110N) (collectively, 110), the one or more security servers 114 may call an SDK (which may be inclusive of multiple APIs) at a mobile microsite server 112 to launch an authorization flow with remote authorization server 116. The authorization workflow allows the remote authorization server 116 to obtain information about the user-specific account directly from mobile device. Such information may be used by remote authorization server 116 to determine whether or not to confirm an amount of gameplay authorization.

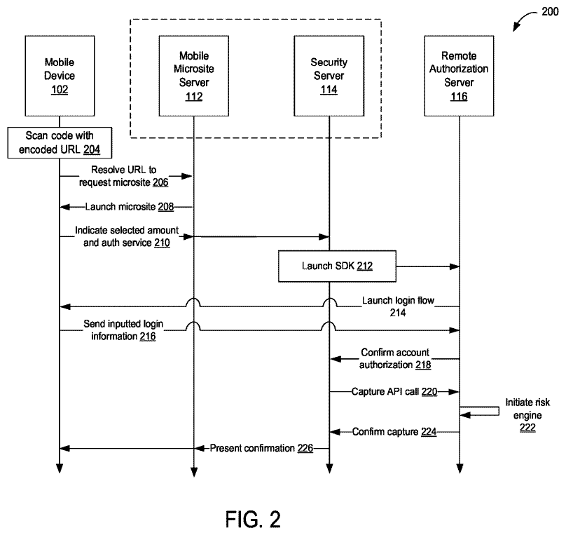

FIG. 2 illustrates an example flow diagram 200 for processing an amount of gameplay authorization based on a risk engine authorization, according to some aspects of the disclosed technology.

Mobile device 102 is associated with a user seeking to obtain account-based authorization to use or obtain a specific service (or obtain a particular good or product). In some cases, the mobile microsite server 112 and the security server 114 may be associated with and controlled by the same entity (e.g., goods or service provider of the goods or service requested by the user), while the remote authorization server 116 may be associated with and controlled by a different entity. As described herein, remote authorization server 116 may communicate directly with mobile device 102 to conduct an authorization or login flow associated with the selections made by mobile device 102 while minimizing certain data exchanges so as to avoid exposing certain data to other devices, systems, or entities.

In some cases, an electronic gaming machine or a POS machine may present a code. The code may be barcodes, quick response (QR) codes, radio frequency identification (RFID) codes, near field communication (NFC) codes or other types of codes that are scannable by the mobile device 102. The mobile device 102 may scan the code in step 204, and in some cases, scanning the code may resolve the encoded URL to automatically generate and send a request for a microsite based on an encoded URL in step 206. More specifically, the request for the microsite is sent to the mobile microsite server 112, which may then launch the microsite in step 208.

A graphic user interface of the microsite may be provided to the mobile device 102, and the graphic user interface may display one or more input fields in which a user may provide inputs that indicate an amount of gameplay activity requested for authorization and an associated remote authorization service (e.g., account type or servicer). The inputted amount of gameplay as well as the selected remote authorization service may be sent to the security server 114 in step 210. For example, the user may input selections from a menu of different options each corresponding to different amounts of gameplay activity. For example, a player may wish to engage in multiple turns or spins on a slot machine over an hour of gameplay. Each turn may correspond to different numbers of virtual or digital chips, tokens, points, wagering amounts, etc., with which the user may wish to engage in gameplay. The options presented may thus correspond to different multipliers of the number required for each session (e.g., pull, turn, deal, or other type of gaming activity) at the electronic gaming machine 110, and the user may select how much is likely needed to allow for the desired amount of gameplay. The user may also be presented with different options for different remote authorization services (e.g., authorization of transfer, payment, or other transaction from specified banking accounts or account management servicer systems), and the user may select one remote authorization service in relation to the servicer with which the user may have an account.

The security server 114 may then launch a software development kit (SDK) provided by or associated with the remote authorization server 116, based on the selected gameplay amount to a remote authorization server 116 and the selected remote authorization service at step 212. In step 214, the remote authorization server 116 may then launch an authorization or login flow with the mobile device 102, which may be presented within similar graphic user interface as the microsite for a consistent user experience but which is conducted directly with mobile device and without providing associated data to mobile microsite server 112. The authorization flow may include presenting the mobile device 102 with content associated with and provided by the remote authorization server 116, including requests for information in accordance with the security requirements of the identified remote authorization service (e.g., specific account servicer) in a seamless transition and handoff from the microsite provided by mobile microsite server 112. Thus, the user of the mobile device 102 may be presented with an integrated, streamlined, and seamless user experience in which a variety of different types of remote authorization services (each of which may be associated with different security requirements and risks) may be used to confirm authorization(s), all while limiting exposure of authentication and login data. The authorization(s) may be electronically communicated to service provider systems, which may then use the same in generating operating instructions for service provider machinery to provide the requested goods or services.

The graphic user interface provided by remote authorization server 116 and presented to the mobile device 102 may be automatically populated based on the selected gameplay amount provided to the remote authorization server 116. The mobile device 102 may then provide the requested login information (e.g., user identifier, password, answers to security questions) associated with the requested account authorization to the remote authorization server 116 in step 216. In some cases, the remote authorization server 116 may store and present information about an original amount available to the user from a user account, as well as a projected amount after the original amount is decreased based on the selected amount of gameplay authorization. As such, remote authorization server 116 may confirm an amount associated with the user account (e.g., as specified by the requested remote authorization service) that may be available for authorizing gameplay and/or more specifically, confirm that the amount of the user account is sufficient to be used in association with the selected amount of gameplay. If the remote authorization server 116 confirms sufficiency of the amount in the user account, the remote authorization server 116 may return confirmation that the requested amount is authorized to be used for gameplay in step 218.

In step 220, the security server 114 may further make a capture API call to the remote authorization server 116 so as to execute capture (e.g., digital transfer or exchange) of the amount corresponding to the selected amount of gameplay activity. In step 222, the remote authorization server 116 may also initialize and call a risk engine to generate a risk assessment associated with the capture based on current conditions and aggregated data (including data models) regarding similar conditions. Such conditions may be specific to the user or user information from the remote authorization server 116 that was accessed based on provided login information at the mobile device. The conditions may also be analyzed in relation to historical patterns associated with the user account. In some cases, the risk engine may be stored locally at the remote authorization server 116 or another remote server that is associated with and/or accessible by the remote authorization server 116. The risk engine may be called to evaluate the current conditions and generate one or more risk assessment based on comparisons to aggregated or historical data (which may be part of data models trained to correlate different conditions to risk levels). The risk assessment(s) may include evaluating whether a creditable amount associated with the inputted amount of gameplay authorization is available in an account at the remote authorization server 116. In some cases, the risk engine may determine, based on historical datapoints and whether there is the creditable amount, whether to send a confirmation to the security server 114. Once capture is confirmed and the assessment indicates that the risk level is below an indicated threshold amount, the authorized gameplay amount may be confirmed with security server 114. In some implementations, security server 114 may initiate or send instructions to downstream devices (e.g., electronic gaming machines 110) as to how to provide the requested goods or services in accordance with the authorization. In some cases, a confirmation is also sent and presented at the mobile device 102 in step 226.

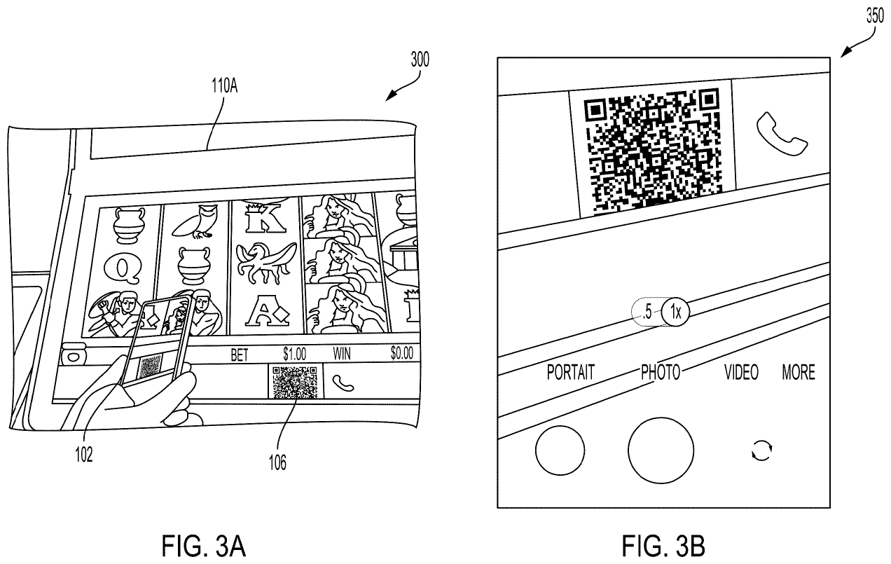

FIG. 3A illustrates an example use of a mobile device to scan a code associated with an electronic gaming machine, according to some aspects of the disclosed technology. The example scenario 300 includes using a camera of a mobile device 102 to scan a code 106 that is on a screen of an electronic gaming machine 110A.

FIG. 3B illustrates an example camera view or image of the mobile device scanning the code, according to some aspects of the disclosed technology. The example graphical user interface camera view 350 shows that the code 106 may be captured in a scan, photo, or image capture.

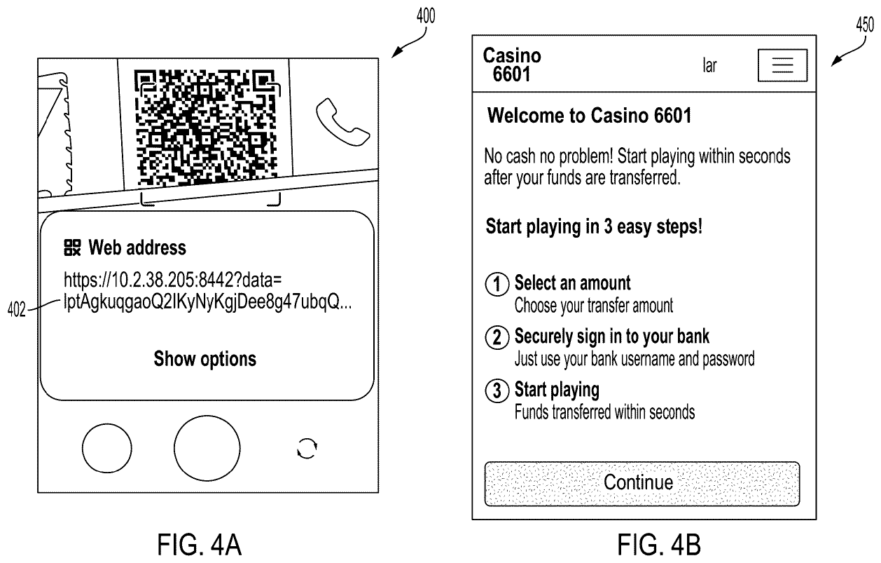

FIG. 4A illustrates an example graphical user interface 400 showing a uniform resource locator (URL) encoded within an image scanned by the camera, according to some aspects of the disclosed technology. The URL 402 encoded in the image is opened at the mobile device, which launches the mobile microsite.

FIG. 4B illustrates an example graphical user interface of an instructional splash that provides the steps to be performed by a user, according to some aspects of the disclosed technology. The launched mobile microsite may start with the instructional splash screen 450. The instructional splash screen 450 may include steps including, selecting an authorization amount, logging into a remote authorization service, and authorizing the gameplay amount.

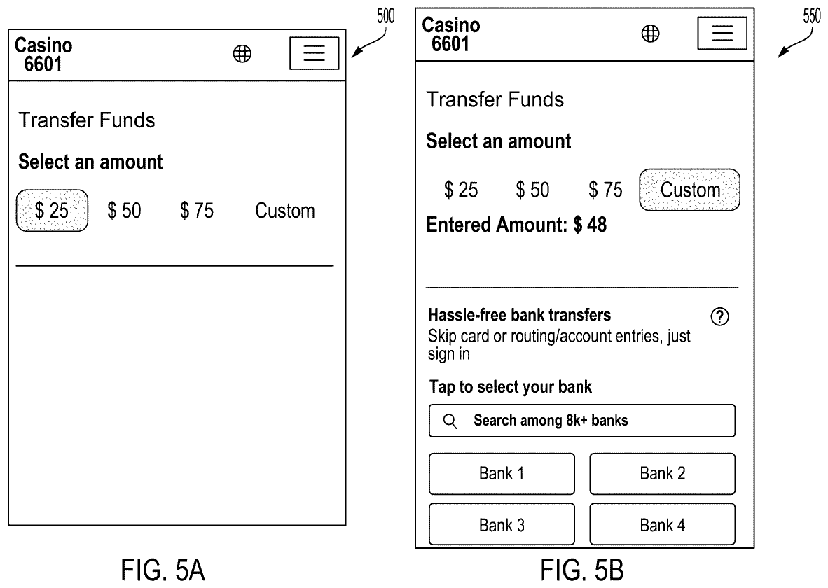

FIG. 5A illustrates an example graphical user interface of selectable gameplay amounts, according to some aspects of the disclosed technology. The example graphical user interface 500 may includes selectable amounts for gameplay, which may also include an option to input a custom amount.

FIG. 5B illustrates an example graphical user interface of selectable remote authorization services, according to some aspects of the disclosed technology. The example graphical user interface 550 may further include options for remote authorization services 116 that a user can user to authorize an amount of gameplay based on creditable amounts associated with accounts held in association with the remote authorization services.

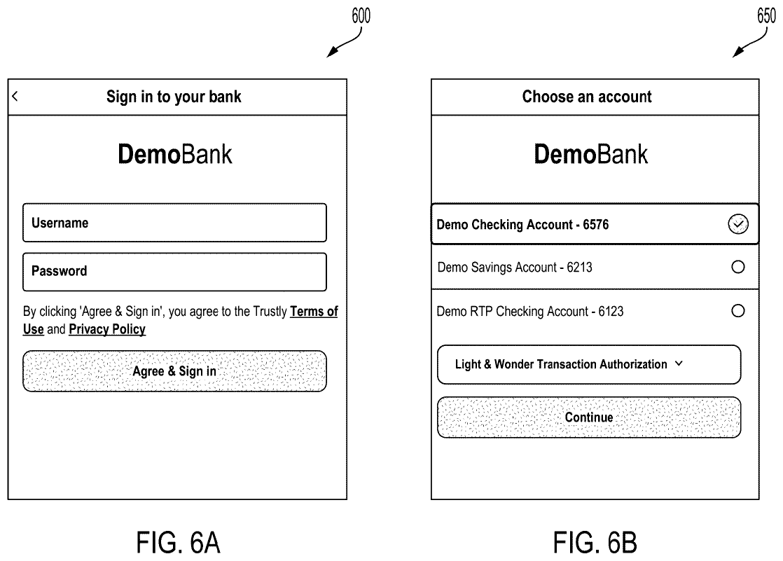

FIG. 6A illustrates an example graphical user interface of a login screen for authenticating login information associated with a selected remote authorization service, according to some aspects of the disclosed technology. The example graphical user interface 600 may include input options for entering a username and password that is associated with a user account at a selected remote authorization service.

FIG. 6B illustrates an example graphical user interface of selectable accounts associated with the authenticated login information, according to some aspects of the disclosed technology. The example graphical user interface 650 may include one or more account associated with the user account with the entered login information. Each account may have different creditable amounts associated therein.

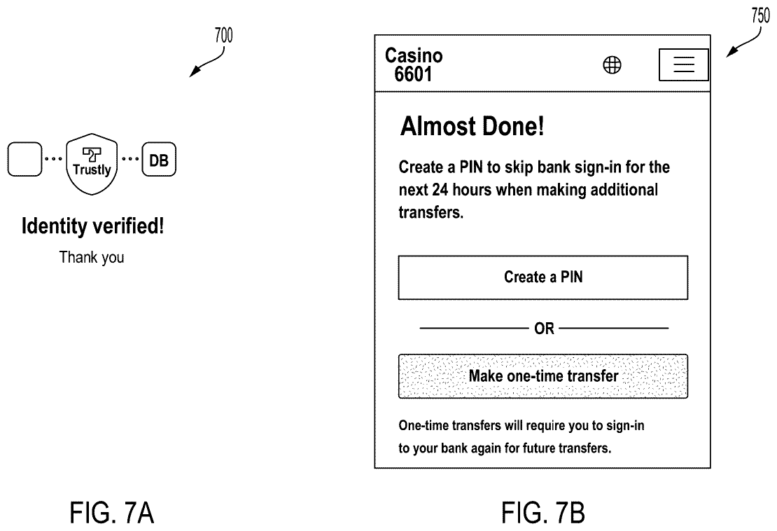

FIG. 7A illustrates an example graphical user interface of a successful authentication of the login information and authorization of the selected amount from the selected account, according to some aspects of the disclosed technology. Once the login information is entered and the account information is selected, the example graphical user interface 700 of a successful authentication may be presented.

FIG. 7B illustrates an example graphical user interface of an option to create a personal identification number (PIN) associated with the selected account or make a one-time authorization, according to some aspects of the disclosed technology. In some cases, the example graphical user interface 750 may present an option to create a PIN or to make a one-time authorization. The PIN created may be associated with the selected account. Therefore, for a single user account, more than one PIN may be created such that the user can quickly select different accounts to authenticate a gameplay amount.

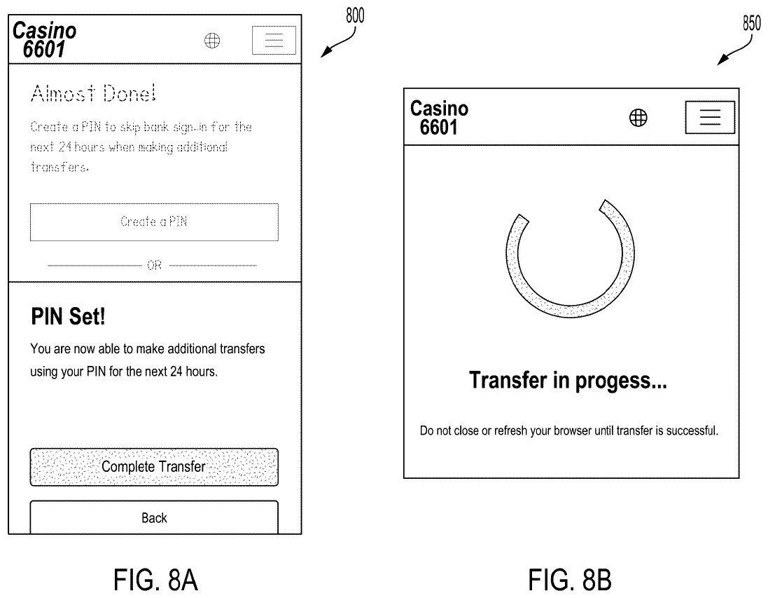

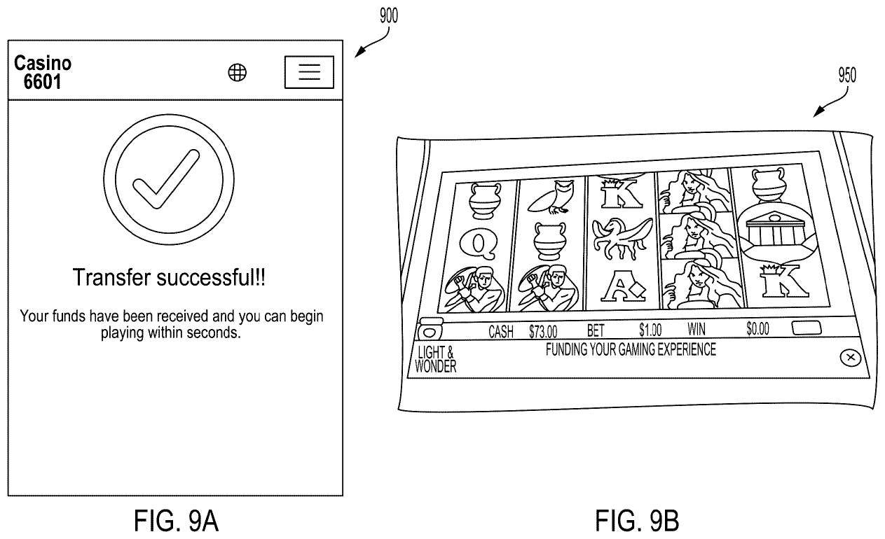

FIG. 8A illustrates an example graphical user interface that shows that a PIN has been set and an option to complete the authorization of the selected amount from the selected account, according to some aspects of the disclosed technology. The example graphical user interface 800 includes an option to complete the authorization after setting a PIN, which may be used in a next point in time. FIG. 8B illustrates an example graphical user interface illustrating a pending authorization screen 850, according to some aspects of the disclosed technology. FIG. 9A illustrates an example graphical user interface 900 illustrating a successful authorization screen, according to some aspects of the disclosed technology.

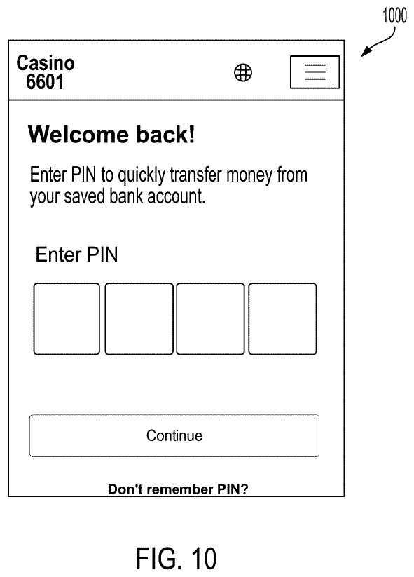

FIG. 9B illustrates an example graphical user interface 950 of an electronic gaming machine that has the authorized amount available for gameplay, according to some aspects of the disclosed technology. FIG. 10 illustrates an example graphical user interface 1000 of the mobile device at a second time after a PIN has been set for the user to select the PIN associated with the selected account, according to some aspects of the disclosed technology. The example graphical user interface 1000 provides a different version of the microsite.

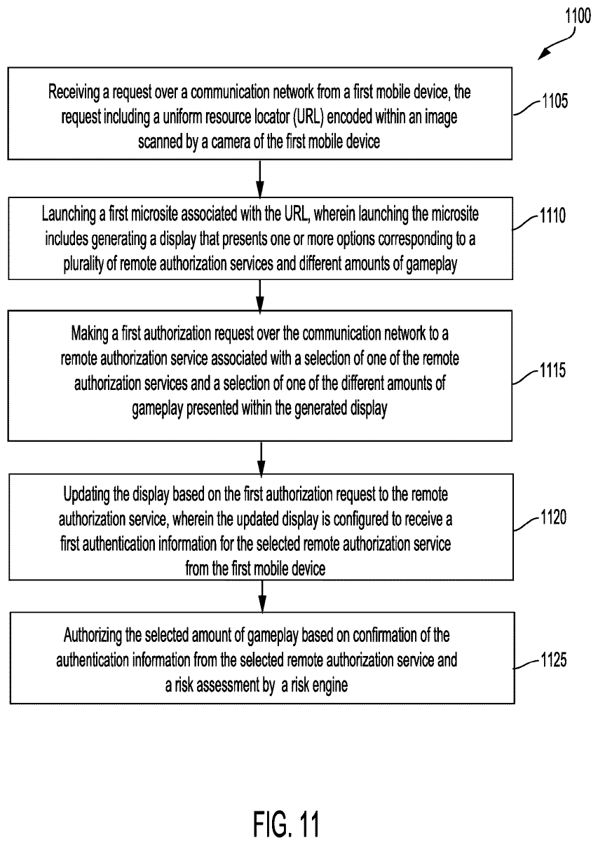

FIG. 11 illustrates steps of an example process for processing an amount of gameplay authorization based on a risk engine authorization according to some aspects of the disclosed technology, according to some aspects of the disclosed technology. Although the example method 1100 depicts a particular sequence of operations, the sequence may be altered without departing from the scope of the present disclosure. For example, some of the operations depicted may be performed in parallel or in a different sequence that does not materially affect the function of method 1100. In other examples, different components of an example device or system that implements method 1100 may perform functions at substantially the same time or in a specific sequence.

Process 1100 begins with step 1105, wherein, in some cases a security server, receives a request over a communication network from a first mobile device, the request including a uniform resource locator (URL) encoded within an image scanned by a camera of the first mobile device. In step 1110, a first microsite associated with the URL may be launched. In some cases, a user first scans a code at an electronic gaming machine that launches the microsite. Launching the microsite may include generating a display that presents one or more options corresponding to a plurality of remote authorization services and different amounts of gameplay. The user may then enter information at the microsite, including an amount of gameplay to authorize and a remote authorization service that the user wants to use to confirm the amount of gameplay to authorize. In addition, the security server may launch the login flow at the mobile device, where the user may input their login information (e.g., a first login information) associated with a remote authorization service (e.g., a first remote authorization service).

The first login information may be authenticated at the first remote authorization service. In some cases, a virtual credential token, such as a split token, that represent the first login information that logged into the first remote authorization service may be stored in association with a PIN. In addition, the virtual credential token may be stored with a plurality of other virtual credential tokens associated with respective users in memory. The virtual credential tokens may represent identity information to log in to respective remote authorization services that provide authorization for gameplay amount. Furthermore, the virtual credential tokens may be linked to respective unique identifiers associated with respective mobile devices and one or more personal identification numbers (PINs) selected by the respective users at the respective mobile devices. The one or more PINs may be associated with respective accounts of a user account associated with the identity information to log in to respective remote authorization services.

In step 1115, a first authorization request may be made over the communication network to a remote authorization service associated with a selection of one of the remote authorization services and a selection of one of the different amounts of gameplay presented within the generated display. The information of the first remote authorization service provides insights into whether or not the security server should authorize the requested amount of gameplay. In step 1120, the display based on the first authorization request to the remote authorization service may be updated. The updated may be is configured to receive a first authentication information for the selected remote authorization service from the first mobile device.

In step 1125, the selected amount of gameplay may be authorized based on confirmation of the authentication information from the selected remote authorization service and a risk assessment by a risk engine. The risk engine may be initiated and called to confirm the authorization of the first amount of gameplay based on such information. For example, the risk engine may evaluate whether a creditable amount associated with the first amount of gameplay is available in an account associated with the remote authorization service. In addition, the risk engine may further determine whether to send the first confirmation to the first electronic gaming machine based on historical datapoints and whether there is the creditable amount. In some case, the historical datapoints are used to train a machine-learning model to correlate one or more conditions to one or more risk levels, and wherein determining whether to send the first confirmation includes applying the machine-learning model to a set of conditions associated with the request. In some cases, a first confirmation may be sent to a first electronic gaming machine over the communication network, wherein the confirmation authorizes the selected amount of gameplay at the first electronic gaming machine. In some cases, the authorized first amount of gameplay corresponds to a number of virtual tokens for gameplay. In some cases, the first electronic gaming machine is a gambling machine operable to conduct a game of chance.

In some cases, at a second time after sending the confirmation to permit the first amount of gameplay and after the PIN is stored, a second call to launch the authorization flow between the first mobile device and the first electronic gaming machine through the microsite at the first mobile device may be received. The PIN from the first mobile device and the first unique identifier associated with the first mobile device to authenticate the first user may be received. Access to information of the first remote authorization service may be authorized as well as the selected account associated with the PIN, instead of with a login but with on PIN and the first unique identifier associated with the first mobile device. The risk engine may be initialized to confirm that the authorization of the second amount of gameplay from the selected account, and a second confirmation may be sent to the electronic gaming machine, wherein the confirmation authorizes the second amount of gameplay at the first electronic gaming machine.

In some cases, at a different second time after sending the confirmation to permit the first amount of gameplay and after the PIN is stored, a second call to launch the authorization flow between the first mobile device and a different second electronic gaming machine through the microsite at the first mobile device may be received. In other words, the user may use the same PIN at a different electronic gaming machine to authorize another amount of gameplay. Similarly, the PIN from the first mobile device and the first unique identifier associated with the first mobile device is used to authenticate the first user. Access to information of the first remote authorization service may be authorized, instead of with a login but with on PIN and the first unique identifier associated with the first mobile device. The risk engine may be initialized to confirm that the authorization of the second amount of gameplay, and a second confirmation may be sent to the second electronic gaming machine, wherein the confirmation authorizes the second amount of gameplay at the second electronic gaming machine.

In some cases, at another different second time, a second API call to launch the authorization flow between a second mobile device associated with a second user and a second electronic gaming machine through the microsite at the second mobile device may be received. In other words, a second user with a second mobile device may user a second electronic gaming machine and processing an amount of gameplay authorization based on a risk engine authorization similarly to the first user.

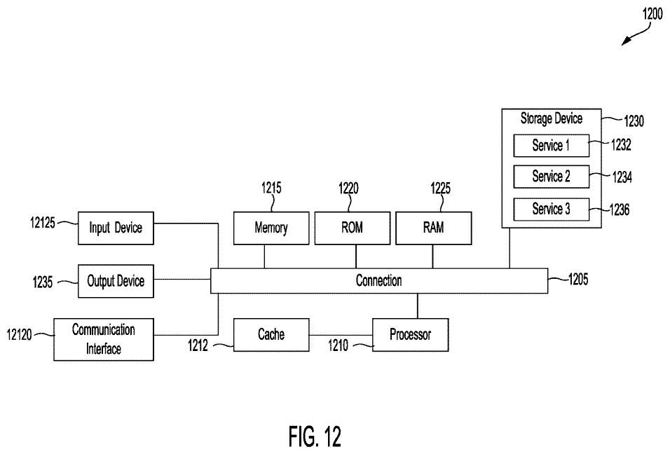

FIG. 12 illustrates an example processor-based system with which some aspects of the subject technology can be implemented. For example, processor-based system 1200 that can be any computing device that is configured to generate and/or display customized video content for a user and/or which is used to implement all, or portions of, a multimedia editing/playback platform, as described herein. By way of example, system 1200 can be a personal computing device, such as a smart phone, a notebook computer, or a tablet computing device, etc. Connection 1205 can be a physical connection via a bus, or a direct connection into processor 1210, such as in a chipset architecture. Connection 1205 can also be a virtual connection, networked connection, or logical connection.

In some embodiments, computing system 1200 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 1200 includes at least one processing unit (CPU or processor) 1210 and connection 1205 that couples various system components including system memory 1215, such as read-only memory (ROM) 1220 and random-access memory (RAM) 1225 to processor 1210. Computing system 1200 can include a cache of high-speed memory 1212 connected directly with, in close proximity to, and/or integrated as part of processor 1210.

Processor 1210 can include any general-purpose processor and a hardware service or software service, such as services 1232, 12312, and 1236 stored in storage device 1230, configured to control processor 1210 as well as a special-purpose processor where software instructions are incorporated into the actual processor design. Processor 1210 may essentially be a completely self-contained computing system, containing multiple cores or processors, a bus, memory controller, cache, etc. A multi-core processor may be symmetric or asymmetric.

To enable user interaction, computing system 1200 includes an input device 12125, which can represent any number of input mechanisms, such as a microphone for speech, a touch-sensitive screen for gesture or graphical input, keyboard, mouse, motion input, speech, etc. Computing system 1200 can also include output device 1235, which can be one or more of a number of output mechanisms known to those of skill in the art. In some instances, multimodal systems can enable a user to provide multiple types of input/output to communicate with computing system 1200. Computing system 1200 can include communications interface 12120, which can generally govern and manage the user input and system output.

The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communications interface 1240 may also include one or more Global Navigation Satellite System (GNSS) receivers or transceivers that are used to determine a location of the computing system 1200 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1230 can be a non-volatile and/or non-transitory computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a Blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

Storage device 1230 can include software services, servers, services, etc., that when the code that defines such software is executed by the processor 1210, it causes the system to perform a function. In some embodiments, a hardware service that performs a particular function can include the software component stored in a computer-readable medium in connection with the necessary hardware components, such as processor 1210, connection 1205, output device 1235, etc., to carry out the function.

By way of example, processor 1210 may be configured to execute operations for processing an amount of gameplay authorization based on a risk engine authorization. By way of example, processor 1210 may be provisioned to execute any of the operations discussed above with respect to process 300, described in relation to FIGS. 1, 2, and 11. By way of example, processor 1210 may be configured to receive a first application programming interface (API) call over a communication network to launch an authorization flow between a first mobile device associated with a first user and a first electronic gaming machine through a microsite at the first mobile device. In some aspects, the processor 1210 may receive a first login information for a first remote authorization service from the mobile device over the communication network, wherein the first login information is authenticated at the first remote authorization service. In some aspects, processor 1210 may be further configured to authorize access to information of the first remote authorization service based on confirmed login information from the first remote authorization service.

In some aspects, processor 1210 may be further configured for initiate a risk engine to confirm the authorization of the first amount of gameplay. In some aspects, processor 1210 can be further configured to send a first confirmation to the electronic gaming machine over the communication network, wherein the confirmation authorizes the first amount of gameplay at the electronic gaming machine.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules can be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

What is claimed is:

1. A method of integrated mobile microsites for remote authorization, the method comprising:
receiving a request sent over a communication network from a security server to a remote authorization server, the request including information received at a microsite associated with a uniform resource locator (URL) encoded within an image scanned by a camera of the first mobile device;
identifying that the request includes selections made from among one or more options corresponding to a plurality of different remote authorization services and different amounts of gameplay;
launching a first authorization workflow over the communication network between the first mobile device and the remote authorization server in accordance with the selected remote authorization service of the plurality of remote authorization services and the selected amount of gameplay;
updating a display presented to the first mobile device based on the first authorization workflow and the selected remote authorization service, wherein the updated display is configured to receive a first authentication information for a user account of the selected remote authorization service from the first mobile device; and
sending an authorization confirmation to the security server based on confirmation of the authentication information from the selected remote authorization service and a risk assessment by a risk engine, wherein the authorization confirmation corresponds to the selected amount of gameplay in association with the user account.

2. The method of claim 1, further comprising storing a plurality of virtual credential tokens associated with different user accounts in memory, wherein each of the virtual credential tokens is associated with a personal identification number (PIN), a unique device identifier, and account information associated with one of the different remote authorization services.

3. The method of claim 2, further comprising:
receiving a PIN selection from the first mobile device;
generating a first virtual credential token for the first mobile device; and
storing the first virtual credential token in memory in association with the user account of the selected remote authorization service, the received PIN, a unique identifier of the first mobile device, and account information associated with the selected remote authorization service, the account information including the first authentication information.

4. The method of claim 3, further comprising:
receiving a second request over the communication network from the first mobile device, the request including the URL encoded within another image scanned by the camera of the first mobile device; and
launching a different version of the first microsite based on the second request including the unique identifier of the first mobile device, wherein the different version of the first microsite includes a display that presents a request for the PIN.

5. The method of claim 4, further comprising:
receiving the PIN from the first mobile device at the different version of the first microsite;
automatically launching a second authorization workflow corresponding to the selected remote authorization service based on the unique identifier of the first mobile device and the received PIN matches the stored unique identifier of the first device and the stored PIN associated with the first virtual credential token;
automatically populating a field within a display associated with the selected remote authorization service based on the first authentication information associated with the first virtual credential token; and
authorizing a second amount of gameplay from the user account of the selected remote authorization service based on the stored first virtual credential token and an updated risk assessment by the risk engine concerning the second amount of gameplay.

6. The method of claim 3, further comprising providing an option within a different version of the microsite to switch to a different user account, and providing an option to save a different PIN associated with the different account.

7. The method of claim 3, further comprising:
receiving a second request over the communication network from the first mobile device, the second request including a second URL encoded within an image scanned by the camera of the first mobile device;
launching a second authorization workflow over the communication network corresponding to a second remote authorization service associated with a second selection of the second remote authorization service of the remote authorization services and a second selection of one of the different amounts of gameplay presented within the generated display;
updating the display based on the second authorization workflow to the different remote authorization services, wherein the updated display is configured to receive a second authentication information for the different remote authorization service from the first mobile device; and
authorizing the second selected amount of gameplay based on confirmation of the authentication information from the second remote authorization service and a second risk assessment by the risk engine.

8. The method of claim 1, further comprising calling the risk engine to generate the risk assessment by:
evaluating whether a creditable amount associated with the first amount of gameplay is available in an account at the selected remote authorization service; and
determining, based on historical datapoints and whether there is the creditable amount, whether to authorize the selected amount of gameplay.

9. The method of claim 8, wherein the historical datapoints are used to train a machine-learning model to correlate one or more conditions to one or more risk levels, and wherein determining whether to send the first confirmation includes applying the machine-learning model to a set of conditions associated with the request.

10. The method of claim 9, wherein the historical datapoints used train the machine-learning model are associated with authorizations corresponding to different users and respective creditable amounts.

11. The method of claim 1, wherein the authorized first amount of gameplay corresponds to a number of virtual tokens for gameplay.

12. The method of claim 1, wherein confirmation is a sent to an electronic gaming machine over the communication network, wherein the confirmation authorizes the selected amount of gameplay at the electronic gaming machine.

13. A system of integrated mobile microsites for remote authorization, the system comprising:
a communication interface that communicates over a communication network to receive a request from a security server, the request including information received at a microsite associated with a uniform resource locator (URL) encoded within an image scanned by a camera of the first mobile device;
a processor that executes instructions stored in memory, wherein the processor executes the instructions to:
identify that the request includes selections made from among one or more options corresponding to a plurality of different remote authorization services and different amounts of gameplay;
launch a first authorization workflow over the communication network between the first mobile device and the remote authorization server in accordance with the selected remote authorization service of the plurality of remote authorization services and the selected amount of gameplay;
update a display presented to the first mobile device based on the first authorization workflow and the selected remote authorization service, wherein the updated display is configured to receive a first authentication information for a user account of the selected remote authorization service from the first mobile device; and
wherein the communication interface sends an authorization confirmation to the security server based on confirmation of the authentication information from the selected remote authorization service and a risk assessment by a risk engine, wherein the authorization confirmation corresponds to the selected amount of gameplay in association with the user account.

14. The system of claim 13, wherein the security server is further configured to:
receive a PIN selection from the first mobile device;
generate a first virtual credential token for the first mobile device; and
store the first virtual credential token in memory in association with a user account of the selected remote authorization service, the received PIN, a unique identifier of the first mobile device, and account information associated with the selected remote authorization service, the account information including the first authentication information.

15. The system of claim 14, wherein the mobile microsite server is further configured to
receive a second request over the communication network from the first mobile device, the request including the URL encoded within another image scanned by the camera of the first mobile device; and
launch a different version of the first microsite based on the second request including the unique identifier of the first mobile device, wherein the different version of the first microsite includes a display that presents a request for the PIN.

16. The system of claim 15, wherein the security server is further configured to:
receive the PIN from the first mobile device at the different version of the first microsite;
automatically launch a second authorization workflow to the selected remote authorization service based on the unique identifier of the first mobile device and the received PIN matches the stored unique identifier of the first device and the stored PIN associated with the first virtual credential token;
automatically populate a field within a display associated with the selected remote authorization service based on the first authentication information associated with the first virtual credential token; and
authorize a second amount of gameplay from the user account of the selected remote authorization service based on the stored first virtual credential token and an updated risk assessment by the risk engine concerning the second amount of gameplay.

17. The system of claim 13, wherein the security server is further configured to call the risk engine to generate the risk assessment by:
evaluating whether a creditable amount associated with the first amount of gameplay is available in an account at the selected remote authorization service; and
determining, based on historical datapoints and whether there is the creditable amount, whether to authorize the selected amount of gameplay.

18. The system of claim 17, wherein the historical datapoints are used to train a machine-learning model to correlate one or more conditions in the historical datapoints to one or more risk levels, and wherein the risk engine determines whether to send the confirmation includes applying the machine-learning model to a set of conditions associated with the request.

19. The system of claim 18, wherein the historical datapoints used to train the machine-learning model are associated with authorizations corresponding to different users and respective creditable amounts.

20. A non-transitory, computer-readable storage medium comprising instructions embodied thereon, the instructions executable by a computing system to perform a method of integrated mobile microsites for gameplay authorization, the method comprising:
receiving a request over a communication network from a security server to a remote authorization server, the request including information received at a microsite associated with a uniform resource locator (URL) encoded within an image scanned by a camera of the first mobile device;
identifying that the request includes selections made from among one or more options corresponding to a plurality of different remote authorization services and different amounts of gameplay;
launching a first authorization workflow over the communication network between the first mobile device and the remote authorization server in accordance with the selected remote authorization services of the plurality of remote authorization services and including a selection of one of the different amounts of gameplay;
updating a display presented to the mobile device based on the first authorization workflow and the selected remote authorization service, wherein the updated display is configured to receive a first authentication information for a user account of the selected remote authorization service from the first mobile device; and
sending an authorization confirmation to the security server based on confirmation of the authentication information from the selected remote authorization service and a risk assessment by a risk engine, wherein the authorization confirmation corresponds to the selected amount of gameplay in association with the user account.
